(19) United States
(12) Patent Application Publication
(10) Pub. No.: US 2019/0128368 A1
(43) Pub. Date: May 2, 2019

(54) DAMPER DEVICE FOR VEHICLE

(71) Applicant: EXEDY Corporation, Neyagawa-shi, Osaka (JP)

(72) Inventors: Takeshi SENOUE, Neyagawa-shi, Osaka (JP); Yoshinari YOSHIMURA, Neyagawa-shi, Osaka (JP)

(21) Appl. No.: 16/094,714

(22) PCT Filed: Aug. 15, 2017
(86) PCT No.: PCT/JP2017/029345

§ 371 Date: Oct. 18, 2018

(30) Foreign Application Priority Data
Aug. 26, 2016 (JP) 2016-165609

(51) Int. Cl. F16F 15/134; F16F 15/31

(52) U.S. Cl. CPC F16F 15/134; F16F 15/31

(57) ABSTRACT

A damper device for a vehicle is disposed between a power source and an output-side member in the vehicle. The damper device includes an input-side rotary member, an output-side rotary member, a damper, and an inertia body. The input-side rotary member is coupled to an output end of the power source. The output-side rotary member is coupled to the output-side member. The input-side rotary member and the output-side rotary member are coupled by the damper to be rotatable relatively to each other. The inertia body is coupled to at least one of the input-side rotary member and the output-side rotary member, the inertia body formed by laminating a plurality of plate members.

### CROSS-REFERENCES TO RELATED APPLICATIONS

This application is the U.S. National Phase of PCT International Application No. PCT/JP2017/029345, filed on Aug. 15, 2017. That application claims priority to Japanese Patent Application No. 2016-165609, filed on Aug. 26, 2016. The contents of both applications are herein incorporated by reference in their entirety.

### BACKGROUND

### Technical Field

The present disclosure relates to a damper device, particularly to a damper device for a vehicle, which is disposed between a power source and an output-side member in the vehicle.

### Background Art

A damper device is mounted between a power source such as an engine and a transmission in order to absorb fluctuations in torque of the engine and so forth and transmit a power to an output-side member. Additionally, among this type of damper devices, some of them are directly coupled to an end of a crankshaft of the engine as described in Japan Laid-open Patent Application Publication No. 2014-66258.

The damper device described in Japan Laid-open Patent Application Publication No. 2014-66258 mainly includes a pair of disc plates disposed on an input side, a hub plate disposed on an output side, a plurality of coil springs elastically coupling the disc plates and the hub plate, and an inertia ring. Additionally, one of the pair of disc plates is coupled to the end of the crankshaft, while the inertia ring is mounted to the outer peripheral part of the hub plate.

### BRIEF SUMMARY

As described in Japan Laid-open Patent Application Publication No. 2014-66258, when the damper device is directly coupled to the end of the crankshaft, the inertia ring is required as a member substitute for a flywheel. In general, the inertia ring is disposed in the outermost peripheral part of the damper device and requires a large amount of inertia. Because of this, in many cases, the inertia ring is manufactured by processing a casting that includes protrusions and recesses on the inner and outer peripheral parts thereof so as to fit along the inner wall surface of an engine casing and that of a transmission casing (so as to increase the amount of inertia without interfering with these casings).

However, such an inertia ring manufactured by casting requires a long processing time, and this becomes a factor of cost increase.

It is an object of the present disclosure to obtain a damper device for a vehicle, which includes an inertia ring manufactured easily at low cost.

### Solution to Problems

(1) A damper device for a vehicle according to the present disclosure is disposed between a power source and an output-side member in the vehicle. The damper device includes an input-side rotary member coupled to an output end of the power source, an output-side rotary member coupled to the output-side member, a damper by which the input-side rotary member and the output-side rotary member are coupled to be rotatable relatively to each other, and an inertia body. The inertia body is coupled to at least one of the input-side rotary member and the output-side rotary member, and is formed by laminating a plurality of plate members.

The inertia body is herein made of a plate not a casting. In general, a sheet metal plate has a higher specific gravity than a casting material. Because of this, the sheet metal plate can reliably have a larger amount of inertia than the casting material, where the volumes of both materials are equal.

Additionally, the inertia body is formed by laminating the plurality of plates. Hence, the entire shape of the inertia body can be arbitrarily set by changing the inner and outer peripheral dimensions of the respective plates. In other words, the inertia body can be made, by laminating the plural plates, in a similar shape to a casting that includes protrusions and recesses on the outer and inner peripheral parts thereof. Therefore, it is possible to obtain an inertia ring that is reduced in manufacturing cost than a conventional inertia ring manufactured by casting and cutting.

(2) Preferably, the inertia body includes a first plate member and a second plate member. The first plate member is fixed to at least one of the input-side rotary member and the output-side rotary member by a first fixation member. The second plate member is fixed to the first plate member by a second fixation member.

For example, when the plate members are fixed to the input-side rotary member, one or more rivets are used in general. In fixing the plate members to the input-side rotary member by the one or more rivets, each rivet is required to be sufficiently filled in each of one or more through holes of each member in order to make this fixation rigid.

When it is herein assumed to fix a plurality of plate members to the input-side rotary member by one or more rivets, each of which penetrates all the plurality of plate members, the total volume of aligned through holes of the respective members becomes large. Hence, each rivet cannot be sufficiently filled in each of one or more through holes of each member, whereby rigid fixation cannot be made. Additionally, in many cases, any suitable member other than the rivet (e.g., a screw member) is employed as each fixation member, and is inserted into each long through hole. This makes rigid fixation difficult.

In view of this, it is preferable to fix only the first plate member to the input-side rotary member or the output-side rotary member by the first fixation member, and fix the other second plate member to the first plate member by the second fixation member. In this case, the plate members, composing the inertia body, can be rigidly fixed to the input-side rotary member or the output-side rotary member.

(3) Preferably, the first fixation member and the second fixation member are rivets.

(4) Preferably, at least one of the plurality of plate members included in the inertia body has a different radial dimension from each of the rest of the plurality of plate members.

The inertia body can be made in a shape along the inner wall surface of an engine casing, a transmission casing or so forth by changing the radial dimensions of the plurality of plate members.

(5) Preferably, the inertia body is disposed in an internal space of an engine casing and/or an internal space of a transmission casing. Additionally, radial dimensions of the plurality of plate members are set such that the plurality of plate members are disposed along and away from an inner wall surface of the engine casing and/or an inner wall surface of the transmission casing at a predetermined gap.

(6) Preferably, the inertia body is fixed to one lateral surface of the input-side rotary member. Additionally, the damper device further includes a ring gear. The ring gear includes a gear part on an outer periphery thereof. The ring gear is fixed to the other lateral surface of the input-side rotary member. The other lateral surface is on an opposite side of the one lateral surface to which the inertia body is fixed.

(7) Preferably, each of the plurality of plate members has a continuously annular shape.

In the present advancement described above, an inertia ring of a damper device for a vehicle can be manufactured easily at low cost.

### BRIEF DESCRIPTION OF THE DRAWINGS

FIG. 1 is a cross-sectional view of a damper device according to an exemplary embodiment of the present disclosure.

FIG. 2 is a front view of the damper device shown in FIG. 1.

FIG. 3 is a cross-sectional view of FIG. 2 taken along line

FIG. 4 is a cross-sectional view of FIG. 2 taken along line IV-IV.

### DETAILED DESCRIPTION OF EMBODIMENTS

### Entire Configuration

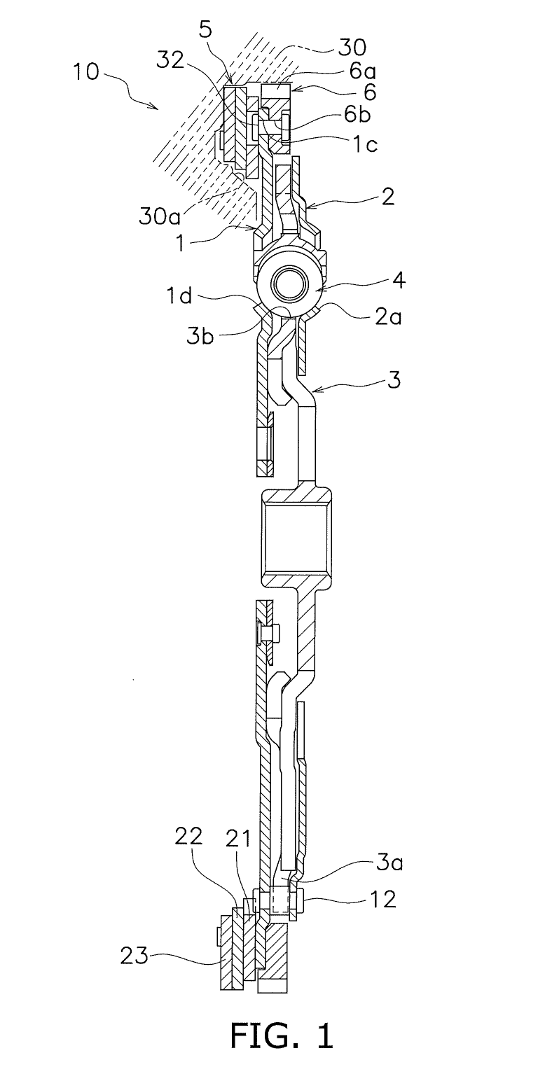

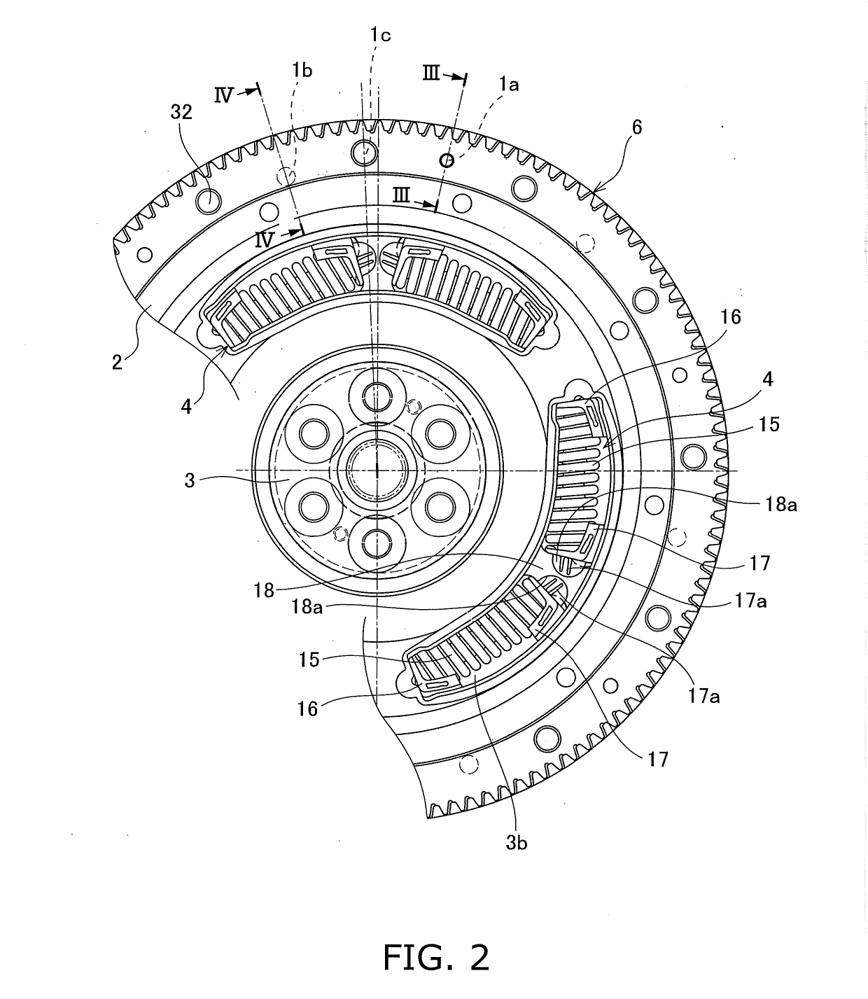

FIGS. 1 and 2 show a damper device 10 according to an exemplary embodiment of the present disclosure. The damper device 10 is disposed between an engine and a transmission, both of which are not shown in the drawings. The damper device 10 transmits a torque from the engine to the transmission, and attenuates fluctuations in torque of the engine. The engine is disposed on the left side in FIG. 1, whereas the transmission is disposed on the right side in FIG. 1. The damper device 10 includes first and second input plates 1 and 2 composing an input-side rotary member, a hub flange 3 provided as an output-side rotary member, a plurality of dampers 4, an inertia ring 5 provided as an inertia body, and a ring gear 6.

### First and Second Input Plates 1 and 2

The first and second input plates 1 and 2, each of which has an annular shape, are disposed in opposition to each other at a gap in an axial direction. The first and second input plates 1 and 2 are fixed by at least one rivet 12, and are immovable relatively to each other in the axial direction and a rotational direction.

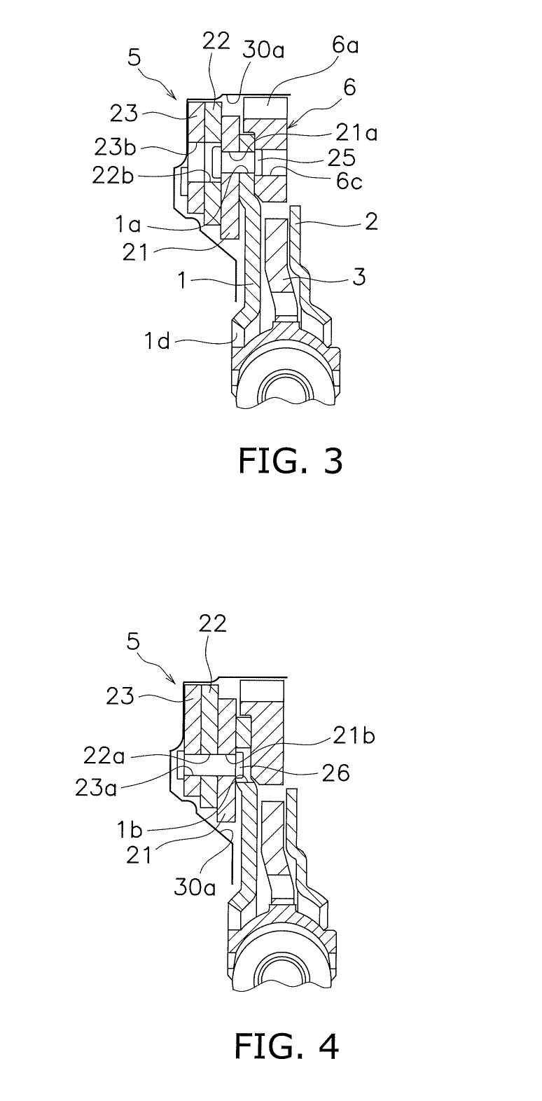

The first input plate 1 is disposed on the engine side, and is fixed at the inner peripheral end thereof to an end surface of a crankshaft of the engine. A plurality of first through holes 1a (see FIGS. 2 and 3), a plurality of second through holes 1b (see FIGS. 2 and 4) and a plurality of third through holes 1c (see FIGS. 1 and 2) are provided in the outer peripheral part of the first input plate 1, while being aligned in a circumferential direction. Additionally, a plurality of window holes 1d are provided in a radially intermediate part of the first input plate 1, while being aligned in the circumferential direction. The second input plate 2 is disposed on the transmission side. The outer periphery of the second input plate 2 has a smaller diameter than that of the first input plate 1, but the inner periphery of the second input plate 2 has a larger diameter than that of the first input plate 1. A plurality of window holes 2a, which are similar to the plurality of window holes 1d of the first input plate 1, are provided in a radially intermediate part of the second input plate 2 so as to be opposed to the window holes 1d, respectively.

### Hub Flange 3

The hub flange 3 is disposed between the first input plate 1 and the second input plate 2 in the axial direction. The hub flange 3 is rotatable relatively to the first and second input plates 1 and 2 in a predetermined angular range. Specifically, the hub flange 3 is provided with at least one cutout 3a (see FIG. 1), each of which extends in the circumferential direction, in the outer peripheral part thereof. The at least one rivet 12, coupling the first and second input plates 1 and 2, passes through the at least one cutout 3a. In other words, the at least one rivet 12 functions as at least one stop pin. Therefore, the hub flange 3 and the first and second input plates 1 and 2 are rotatable relatively to each other in an angular range that the at least one rivet 12 is movable within the at least one cutout 3a.

The hub flange 3 is provided with a plurality of openings 3b, each of which extends in the circumferential direction, in an intermediate part thereof in the radial direction. The plural openings 3b are provided in the same positions as the pairs of window holes 1d and 2a of the first and second input plates 1 and 2, respectively, and accommodate the dampers 4, respectively.

### Dampers 4

As described above, the dampers 4 are accommodated in the openings 3b of the hub flange 3, respectively, and are supported by the pairs of window holes 1d and 2a of the first and second input plates 1 and 2, respectively, in the axial direction and the radial direction. As shown in FIG. 2, each of the dampers 4 includes two coil springs 15, two first spring seats 16, two second spring seats 17, and an intermediate member 18.

In each damper 4, the first spring seats 16 are disposed on one ends of the two coil springs 15, i.e., the ends thereof opposed to the ends of each opening 3b of the hub flange 3. In other words, the one end of each coil spring 15 is supported by each end of each opening 3b through each first spring seat 16. Each second spring seat 17 supports the other end of each coil spring 15. Each second spring seat 17 is provided with two protruding portions 17a, protruding in a roughly circumferential direction, on a surface thereof with which each coil spring 15 does not make contact.

The intermediate member 18 is disposed between the two second spring seats 17 in the circumferential direction. The intermediate member 18 is provided with recesses 18a, having a semicircular shape, on both lateral surfaces thereof in the circumferential direction. The tips of the protruding portions 17a of each second spring seat 17 make contact with each recess 18a. In each damper 4, the two coil springs 15 act in series due to the intermediate member 18 described above. Additionally, the protruding portions 17a of each second spring seat 17 make contact with the inner surface of each recess 18a of the intermediate member 18, whereby each coil spring 15 is compressed in variable directions. Therefore, when compressed, each coil spring 15 can be inhibited from deforming in the radial direction.

### Inertia Ring 5

The inertia ring 5 is formed by laminating a first plate 21, a second plate 22 and a third plate 23, and is attached to the engine-side lateral surface of the first input plate 1. The first to third plates 21, 22 and 23, each of which has an annular shape, have equal thickness. The first to third plates 21, 22 and 23 are formed by, for instance, stamping of an SPHC (steel plate hot commercial).

As shown in FIGS. 3 and 4, the first plate 21 includes a plurality of first through holes 21a and a plurality of second through holes 21b, both of which penetrate therethrough in the axial direction. As shown in FIG. 3, the first plate 21 is fixed to the first input plate 1 by first rivets 25 (first fixation member), each of which penetrates each first through hole 21a and each first through hole 1a of the first input plate 1.

As shown in FIGS. 3 and 4, each of the second and third plates 22 and 23 includes a plurality of first through holes 22a, 23a and a plurality of second through holes 22b, 23b, both of which penetrate therethrough in the axial direction. As shown in FIG. 4, the second and third plates 22 and 23 are fixed to the first plate 21 by second rivets 26 (second fixation member), each of which penetrates each pair of first through holes 22a and 23a of these plates 22 and 23 and each second through hole 21b of the first plate 21. It should be noted that as shown in FIG. 4, each second rivet 26 penetrates each second through hole 1b of the first input plate 1. On the other hand, as shown in FIG. 3, each rivet 25 penetrates each pair of second through holes 22b and 23b of the second and third plates 22 and 23.

It is herein also possible to fix the first to third plates 21, 22 and 23 to the first input plate 1 by the rivets 25. In this case, however, the capacity of aligned through holes penetrating the three plates is large, whereby the aligned through holes are not sufficiently filled with each rivet even when each rivet is swaged to expand the diameter of the trunk thereof. When the aligned through holes are not sufficiently filled with each rivet, the first to third plates 21, 22 and 23 cannot be robustly fixed to the first input plate 1.

In view of this, the configuration herein employed is to fix the single first plate 21 to the first input plate 1 by the rivets 25 and further fix the second and third plates 22 and 23 to the first plate 21 fixed to the first input plate 1 by the second rivets 26. Because of this, each pair of first through holes 21a and 1a of the first plate 21 and the first input plate 1 can be sufficiently filled with each rivet 25, and the first to third plates 21, 22 and 23 can be robustly fixed to the first input plate 1.

As shown in FIGS. 1, 3 and 4, an inner wall surface 30a of an engine casing 30 is disposed in the surroundings of the damper device 10. In other words, the inertia ring 5 is disposed in the internal space of the engine casing 30. Additionally, each of the first to third plates 21, 22 and 23 composing the inertia ring 5 is set to have a radial dimension so as to be disposed along the inner wall surface 30a of the engine casing 30 at a predetermined gap.

Specifically, the outer diameter of the first plate 21 is smaller than that of each of the second and third plates 22 and 23, and the inner diameter of the first plate 21 is smaller than that of each of the second and third plates 22 and 23. Additionally, the outer diameter of the second plate 22 is equal to that of the third plate 23, but the inner diameter of the second plate 22 is smaller than that of the third plate 23.

With the aforementioned settings of the radial dimensions of the first to third plates 21, 22 and 23, the inner peripheral surface of the inertia ring 5 composed of the three plates 21, 22 and 23 is shaped along the inner wall surface 30a of the engine casing 30.

### Ring Gear 6

The ring gear 6 is an annular member and is attached to the transmission-side lateral surface of the first input plate 1. The ring gear 6 includes a gear part 6a, a plurality of first through holes 6b (see FIG. 1) and a plurality of second through holes 6c (see FIG. 3). The gear part 6a is provided on an outer peripheral part of the ring gear 6. The first through holes 6b penetrate the ring gear 6 in the axial direction, while being aligned in the circumferential direction. The second through holes 6b penetrate the ring gear 6 in the axial direction, while being aligned in the circumferential direction. The ring gear 6 is fixed to the first input plate 1 by rivets 32 penetrating the first through holes 6b, respectively. Additionally, the rivets 25 penetrate the second through holes 6c of the ring gear 6, respectively, so as to fix the first plate 21 to the first input plate 1.

### Actions

The damper device 10, including the inertia ring 5 described above, has effects of actions to be described.

(1) The inertia ring 5, which has been conventionally made of a casting, is made of an SPHC. The SPHC has a higher specific gravity than a general casting material. Because of this, the inertia ring 5 in the present exemplary embodiment can reliably have a larger amount of inertia than that made of the general casting material, where the volumes of both materials are equal.

(2) The inertia ring 5 is formed by laminating the plural plates 21 to 23. Hence, the shape of the inertia ring 5 can be arbitrarily set by changing the inner and outer peripheral dimensions of the respective plates 21 to 23. Therefore, the inertia ring 5 can be reduced in manufacturing cost than a conventional inertia ring manufactured by casting and cutting.

(3) In fixating the inertia ring 5 composed of the three plates 21 to 23 to the first input plate 1, only the first plate 21 is fixed to the first input plate 1, and the second and third plates 22 and 23 are fixed to the first plate 21. Therefore, the rivets 25 are sufficiently filled in pairs of through holes 21a and 1a of the first plate 21 and the first input plate 1, respectively, whereby robust fixation can be realized.

### Other Exemplary Embodiments

The present disclosure is not limited to the exemplary embodiment described above, and a variety of changes or modifications can be made without departing from the scope of the present advancement.

(a) In the aforementioned exemplary embodiment, the inertia ring 5 is composed of the three plates 21 to 23. However, the number of plates and the specific shapes of plates are not limited to those in the aforementioned exemplary embodiment.

(b) In the aforementioned exemplary embodiment, the present advancement has been applied to the inertia ring 5 attached to the first input plate 1. However, the present advancement is also similarly applicable to an inertia ring attached to another member such as a hub flange.

(c) In the aforementioned exemplary embodiment, the ring gear 6 is provided separately from the inertia ring 5. However, a gear part can be provided on the outer periphery of the second and third plates in the aforementioned exemplary embodiment, and the inertia ring can be configured to function as a ring gear as well.

### INDUSTRIAL APPLICABILITY

In a damper device for a vehicle according to the present disclosure, an inertia ring can be manufactured easily at low cost.

### REFERENCE SIGNS LIST

1 First input plate (input-side rotary member)

2 Second input plate (input-side rotary member)

3 Hub flange (output-side rotary member)

4 Coil spring

5 Inertia ring (Inertia body)

6 Ring gear

21 First plate

22 Second plate

23 Third plate

25 First rivet (first fixation member)

26 Second rivet (second fixation member)

1. A damper device for a vehicle, the damper device disposed between a power source and an output-side member in the vehicle, the damper device comprising:
an input-side rotary member coupled to an output end of the power source;
an output-side rotary member coupled to the output-side member;
a damper by which the input-side rotary member and the output-side rotary member are coupled to be rotatable relatively to each other; and
an inertia body coupled to at least one of the input-side rotary member and the output-side rotary member, the inertia body formed by laminating a plurality of plate members.

2. The damper device according to claim 1, wherein the inertia body includes
a first plate member fixed to at least one of the input-side rotary member and the output-side rotary member by a first fixation member, and
a second plate member fixed to the first plate member by a second fixation member.

3. The damper device according to claim 2, wherein the first fixation member and the second fixation member are rivets.

4. The damper device according to claim 1, wherein at least one of the plurality of plate members included in the inertia body has a different radial dimension from each of the rest of the plurality of plate members.

5. The damper device according to claim 1, wherein
the inertia body is disposed in an internal space of an engine casing and/or an internal space of a transmission casing, and
radial dimensions of the plurality of plate members are set such that the plurality of plate members are disposed along and away from an inner wall surface of the engine casing and/or an inner wall surface of the transmission casing at a predetermined gap.

6. The damper device according to claim 1, wherein
the inertia body is fixed to one lateral surface of the input-side rotary member, and
the damper device further comprises a ring gear, the ring gear including a gear part on an outer periphery thereof, the ring gear fixed to the other lateral surface of the input-side rotary member, the other lateral surface being on an opposite side of the one lateral surface to which the inertia body is fixed.

7. The damper device according to claim 1, wherein each of the plurality of plate members has a continuously annular shape.
